(19) United States
(12) Patent Application Publication
(10) Pub. No.: US 2012/0321405 A1
(43) Pub. Date: Dec. 20, 2012

(54) TUBE SHEET GROOVING INDEXIBLE END MILL BODY

(76) Inventor: MICHAEL ANTHONY WEISEL, Latrobe, PA (US)

(21) Appl. No.: 13/159,901

(22) Filed: Jun. 14, 2011

(51) Int. Cl. B23C 3/34; B23C 5/28; B23C 5/10; B23C 5/22

(52) U.S. Cl. 409/143; 407/51; 407/11; 407/48

(57) ABSTRACT

A grooving tool body for holding a number of inserts for use in forming one or more grooves in a wall of a bore when the tool body is rotated about a first axis and simultaneously circularly interpolated about a second axis. The tool body includes a generally cylindrical portion disposed generally about the first axis and having a first end and an opposite second end, the first end being structured to be mounted to a machine tool for simultaneously rotating the tool body about the first axis and circularly interpolating the second end about the second axis. The tool body further includes a number of pockets disposed at or about the opposite second end of the generally cylindrical portion. Each pocket of the number of pockets is structured to receive and couple therein a cutting insert for forming one or more grooves in wall of the bore.

### BACKGROUND

1. Field of the Invention

The invention relates generally to machine tools for cutting grooves in a hole previously formed in a workpiece and, more particularly, to a grooving tool body and a grooving tool assembly.

2. Background Information

It is often necessary or desirable to create an internal recess or groove within a tube or hole of a machine part. Such grooving process is typically carried out in one of two ways. One solution is to use a grooving tool attached to a tool holder on a single axis rotary drive. The end of the grooving tool that is placed in the hole has one or more cutting inserts. These cutting inserts are often radially extendable and retractable. Such feature allows the tool to be inserted into a hole, then rotated and extended radially to form the groove along the inside surface of the hole.

Examples of such extendable inserts are well known in the prior art. U.S. Pat. No. 2,333,935 and U.S. Pat. No. 2,545,443 each shows extendable inserts for internal grooving. Generally, a central rod is moved in an axial direction and has a tapered surface at its end. The tapered surface engages one or more cutting inserts in a wedging action to convert the axial force into a radial force moving the insert into cutting position. The means for moving the central rod is often mechanical, but electrical or hydraulic movement of such a rod is not new to the art. Regardless of the means for effecting movement, an elaborate control system is generally required to control the movement of the central rod. This control is necessary because the position of the central rod determines the diameter of a cut that will be made in the wall of the workpiece.

While such mechanisms have been generally suitable for performing grooving operations, such mechanisms have a number of drawbacks. For one, the complexity and amount of moving parts required for such grooving tools results in a generally high fabrication cost. Also, the complexity of such tools results in more potential points of wear and failure.

Another solution is to use a solid bodied cutting tool having the desired cutting profile formed directly in the body of the cutting tool. As the cutting edges are formed directly in the body of the cutting tool, and thus are not radially extendable or retractable, such cutting tool is used with a machine tool having the ability to both rotate the cutting tool about a first axis, as well as translate the cutting tool along a circular path while rotating the tool about the first axis, thus allowing the tool to form a groove in the wall of a bore. Drawbacks of such solid bodied cutting tools are that once worn from use the tool must either be sent out for resharpening (if possible) or else thrown away.

### SUMMARY OF THE INVENTION

Such deficiencies in the prior art are addressed by embodiments of the invention which are directed to a grooving tool body, a grooving tool assembly, and a machining system for performing grooving operations on a workpiece.

As one aspect of the invention, a grooving tool body for holding a number of inserts for use in forming one or more grooves in a wall of a bore when the tool body is rotated about a first axis and simultaneously circularly interpolated about a second axis is provided. The tool body includes a generally cylindrical portion disposed generally about the first axis and having a first end and an opposite second end. The first end is structured to be mounted to a machine tool for simultaneously rotating the tool body about the first axis and circularly interpolating the second end about the second axis. The tool body also includes a number of pockets disposed at or about the opposite second end of the generally cylindrical portion. Each pocket of the number of pockets is structured to receive and couple therein a cutting insert for forming one or more grooves in the wall of the bore.

The generally cylindrical portion may be formed from a unitary piece of material.

The generally cylindrical portion may include a number of grooves disposed at or about the opposite second end, each groove of the number of grooves being disposed longitudinally generally between two adjacent pockets of the number of pockets.

The generally cylindrical portion may include a coolant channel disposed about the first axis, the coolant channel having a first opening at or about the first end of the generally cylindrical portion and a number of second openings at or about the second end of the generally cylindrical portion. The number of second openings may be disposed in the number of grooves.

Each pocket of the number of pockets may include a threaded bore therein, each threaded bore being structured to receive a threaded screw for securing an insert into the associated pocket.

As another aspect of the invention, a grooving tool assembly for use in forming one or more grooves in a wall of a bore when the tool body is rotated about a first axis and simultaneously circularly interpolated about a second axis is provided. The tool assembly includes a tool body and a number of inserts. The tool body includes a generally cylindrical portion disposed generally about the first axis and having a first end and an opposite second end. The first end is structured to be mounted to a machine tool for simultaneously rotating the tool body about the first axis and circularly interpolating the second end about the second axis. The tool body further includes a number of pockets disposed at or about the opposite second end of the generally cylindrical portion. Each insert of the number of inserts is disposed in a respective pocket of the number of pockets and is structured to form one or more grooves in a wall of a bore when the tool body is rotated about the first axis and simultaneously circularly interpolated about the second axis.

Each pocket of the number of pockets may include a threaded bore therein and each insert of the number of inserts may be coupled in a respective pocket of the number of pockets by a retaining screw threaded in the respective threaded bore.

The generally cylindrical portion may be formed from a unitary piece of material.

The generally cylindrical portion may include a number of grooves disposed at or about the opposite second end, each groove of the number of grooves being disposed longitudinally generally between two adjacent pockets of the number of pockets.

The generally cylindrical portion may include a coolant channel disposed about the first axis, the coolant channel having a first opening at or about the first end of the generally cylindrical portion and a number of second openings at or about the second end of the generally cylindrical portion. The number of second openings may be disposed in the number of grooves.

As yet another aspect of the invention, a machining system is provided. The machining system including a machine tool having a chuck selectively rotatable about a first axis and circularly interpolatable about a second axis and a grooving tool assembly, as previously described, coupled to the chuck.

### BRIEF DESCRIPTION OF THE DRAWINGS

A full understanding of the invention can be gained from the following description of the preferred embodiments when read in conjunction with the accompanying drawings in which:

FIG. 1 is an isometric view of a grooving tool assembly in accordance with an example embodiment of the present invention;

FIG. 2 is a side elevational view of the tool body of FIG. 1;

FIG. 3 is a cross-sectional elevational view of the tool body of FIG. 2;

FIG. 4 is an elevational cross-sectional view of the tool body of FIGS. 1 and 2 taken along line 4-4 of FIG. 2;

FIG. 5 is an elevational cross-sectional view of the grooving tool body of FIGS. 1 and 2 taken along line 5-5 of FIG. 2; and

FIG. 6 is a schematic plan view of a machining system in accordance with an example embodiment of the present invention.

### DESCRIPTION OF THE PREFERRED EMBODIMENTS

Directional phrases used herein, such as, for example, left, right, front, back, top, bottom and derivatives thereof, relate to the orientation of the elements shown in the drawings and are not limiting upon the claims unless expressly recited therein. Identical parts are provided with the same reference number in all drawings.

As used herein, the term “number” shall be used to refer to any non-zero quantity (i.e., one or any quantity greater than one).

As used herein, the term “about” shall be used to refer to a point near, or at, a particular identified point (i.e., proximate).

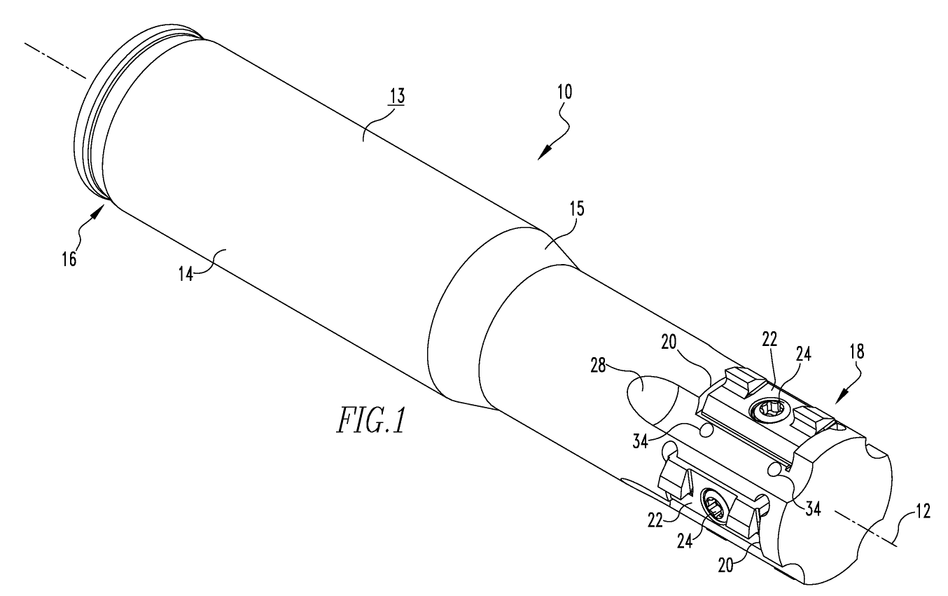

FIG. 1 depicts an example grooving tool assembly 10, in accordance with a non-limiting embodiment of the present invention, for conducting cutting/grooving operations on an interior wall of a bore formed in a workpiece (not shown) when cutting tool assembly 10 is rotated about a central longitudinal axis 12. Continuing to refer to FIG. 1, cutting tool assembly 10 includes a tool body 13 having a generally cylindrical portion 14 disposed about the central longitudinal axis 12. The generally cylindrical portion 14 includes a first end 16 adapted to be coupled to a machine tool (not shown) and an opposite second end 18. Generally cylindrical portion may be of generally constant diameter or alternately, as shown in the example embodiment of FIG. 1, the generally cylindrical portion 14 may include portions (not numbered) of different diameters generally separated by a stepped portion 15 and is preferably, although not necessarily, formed from a single unitary piece of material, such as tool steel or other suitable material, as shown in the cross-sectional view of FIG. 3.

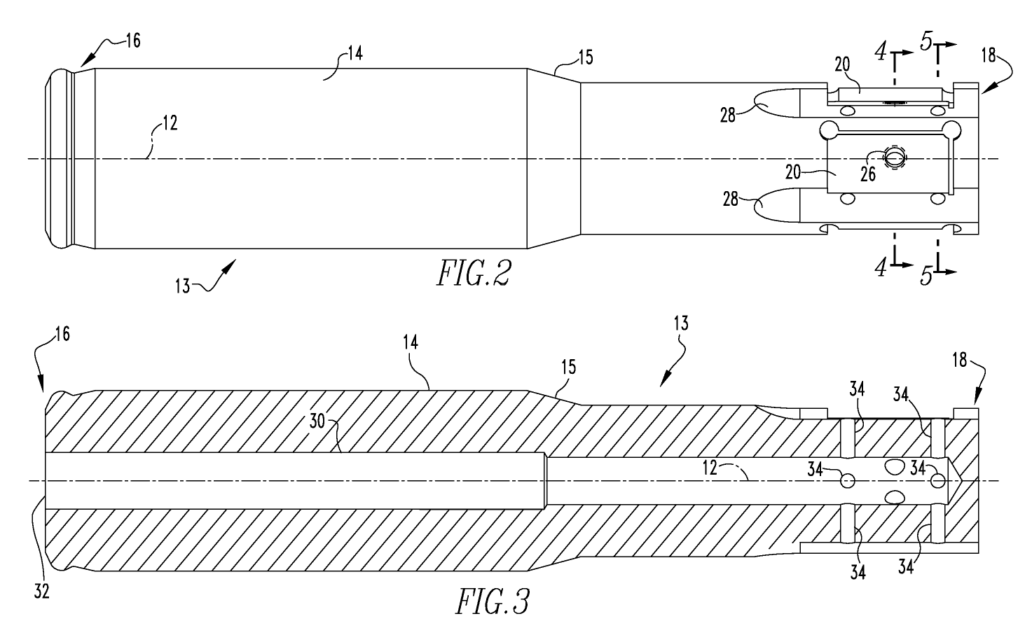

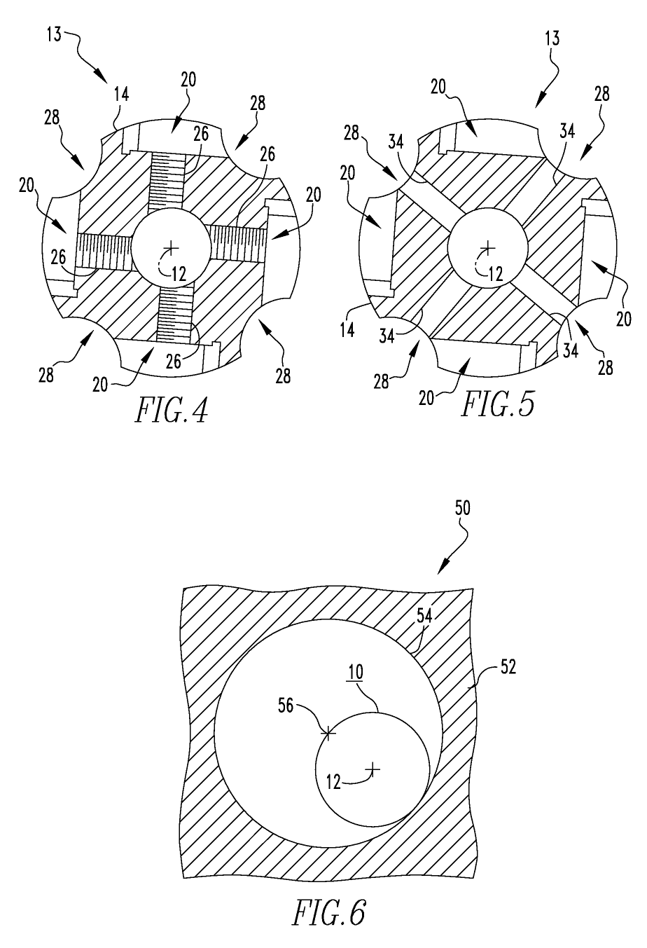

Referring generally to FIGS. 2, 4 and 5, the generally cylindrical portion 13 of tool body 14 includes a number (4 in the illustrated example) of pockets 20 formed generally at or about the opposite second end 18, with each pocket 20 of the number of pockets being structured to receive and couple therein a cutting insert 22 (FIG. 1) for forming one or more grooves in the wall of a bore previously formed in a workpiece, as discussed in greater detail below. As shown in the example embodiment of FIG. 1, each insert 22 may be coupled in/to a respective pocket 20 by a threaded screw 24 that cooperative engages a threaded bore 26 (FIGS. 2 and 4) formed in the generally cylindrical portion 13 at or about the pocket 20. It is to be appreciated that such coupling may be accomplished via other suitable coupling means without varying from the scope of the present invention.

In order to promote chip evacuation away from the cutting inserts 22, cylindrical portion 14 of tool body 13 preferably includes a number (4 in the illustrated example) of grooves 28 formed at or about the opposite second 18. As shown in FIGS. 1, 4 and 5, each groove 28 is disposed generally longitudinally between two adjacent pockets 20.

In order to provide cooling to the cutting tool assembly 10 during cutting operations, the cylindrical portion 14 of tool body 13 preferably includes one or more coolant passages, such as the centrally disposed coolant passage 30 shown in the example embodiment illustrated in FIG. 3, for providing a flow of coolant (not shown) generally from the first end 16 to the opposite second end 18 of the generally cylindrical portion 14. Accordingly, as shown in FIG. 3, coolant passage 30 extends generally from a first opening 32 at or about first end 16 to a number of second openings 34 disposed at or about the opposite second end 18. As shown in the illustrated embodiment, the number of second openings may be provided in the number of grooves 28 in order to ensure the coolant is provided generally at or about the cutting inserts and thus the surface of the bore being cut (grooved). Although only one centrally located coolant passage 30 is shown in the illustrated embodiment it is to be appreciated that other numbers of coolant passages having different orientations from that shown may be employed without varying from the scope of the present invention.

Having thus described an example embodiment of a cutting tool assembly, an example machining system 50 in accordance with an embodiment of the invention will be described in conjunction with FIG. 6 which shows the tool assembly 10 disposed in a bore 54 of a workpiece 52. Bore 54 was previously formed in the workpiece 52 about a central axis 56. In order to perform a groove cutting operation, the grooving tool assembly 10, having at least one cutting insert 22 mounted thereon, is mounted in a machine tool (not shown) capable of rotating the tool assembly 10 about the central longitudinal axis 12 while simultaneously circularly interpolating the tool assembly 10 about a second axis, such as central axis 56 of bore 54. Through such simultaneous rotation and interpolation of tool assembly 10, a groove is effectively formed in the bore 54 of workpiece 52. It is to be appreciated that depending on the particular application, the present invention provides for the use of one or more cutting inserts 22 mounted to the tool body 13.

While specific embodiments of the invention have been described in detail, it will be appreciated by those skilled in the art that various modifications and alternatives to the details provided herein could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A grooving tool body for holding a number of inserts for use in forming one or more grooves in a wall of a bore when the tool body is rotated about a first axis and simultaneously circularly interpolated about a second axis, the tool body comprising:
a generally cylindrical portion disposed generally about the first axis and having a first end and an opposite second end, the first end being structured to be mounted to a machine tool for simultaneously rotating the tool body about the first axis and circularly interpolating the second end about the second axis; and
a number of pockets disposed at or about the opposite second end of the generally cylindrical portion, each pocket of the number of pockets being structured to receive and couple therein a cutting insert for forming one or more grooves in the wall of the bore.

2. The grooving tool of claim 1 wherein the generally cylindrical portion is formed from a unitary piece of material.

3. The grooving tool of claim 1 wherein the generally cylindrical portion comprises a number of grooves disposed at or about the opposite second end, each groove of the number of grooves being disposed longitudinally generally between two adjacent pockets of the number of pockets.

4. The grooving tool of claim 3 wherein the generally cylindrical portion comprises a coolant channel disposed about the first axis, the coolant channel having a first opening at or about the first end of the generally cylindrical portion and a number of second openings at or about the second end of the generally cylindrical portion.

5. The grooving tool of claim 4 wherein the number of second openings are disposed in the number of grooves.

6. The grooving tool of claim 1 wherein each pocket of the number of pockets comprises a threaded bore therein, each threaded bore being structured to receive a threaded screw for securing an insert into the associated pocket.

7. A grooving tool assembly for use in forming one or more grooves in a wall of a bore when the tool body is rotated about a first axis and simultaneously circularly interpolated about a second axis, the grooving tool assembly comprises:
a tool body comprising:
a generally cylindrical portion disposed generally about the first axis and having a first end and an opposite second end, the first end being structured to be mounted to a machine tool for simultaneously rotating the tool body about the first axis and circularly interpolating the second end about the second axis; and
a number of pockets disposed at or about the opposite second end of the generally cylindrical portion; and
a number of cutting inserts, each insert of the number of inserts being disposed in a respective pocket of the number of pockets,
wherein each insert of the number of inserts is structured to form one or more grooves in a wall of a bore when the tool body is rotated about the first axis and simultaneously circularly interpolated about the second axis.

8. The grooving tool assembly of claim 7 wherein each pocket of the number of pockets comprises a threaded bore therein and wherein each insert of the number of inserts is coupled in a respective pocket of the number of pockets by a retaining screw threaded in the respective threaded bore.

9. The grooving tool assembly of claim 7 wherein the generally cylindrical portion is formed from a unitary piece of material.

10. The grooving tool assembly of claim 7 wherein the generally cylindrical portion comprises a number of grooves disposed at or about the opposite second end, each groove of the number of grooves being disposed longitudinally generally between two adjacent pockets of the number of pockets.

11. The grooving tool assembly of claim 10 wherein the generally cylindrical portion comprises a coolant channel disposed about the first axis, the coolant channel having a first opening at or about the first end of the generally cylindrical portion and a number of second openings at or about the second end of the generally cylindrical portion.

12. The grooving tool assembly of claim 11 wherein the number of second openings are disposed in the number of grooves.

13. A machining system for performing grooving operations on a bore formed in a workpiece, the machining system comprising:
a machine tool having a chuck selectively rotatable about a first axis and circularly interpolatable about a second axis; and
a grooving tool assembly as recited in claim 13 coupled to the chuck.
